(19) United States
(12) Patent Application Publication
(10) Pub. No.: US 2013/0225288 A1
(43) Pub. Date: Aug. 29, 2013

(54) MOBILE GAMING PLATFORM SYSTEM AND METHOD

(71) Applicants: Roman Levin, Maalot (IL); Oren Shtark, Haifa (IL); Yonatan Mor, Haifa (IL)

(72) Inventors: Roman Levin, Maalot (IL); Oren Shtark, Haifa (IL); Yonatan Mor, Haifa (IL)

(21) Appl. No.: 13/814,818

(22) PCT Filed: Aug. 9, 2011
(86) PCT No.: PCT/IL11/00650

§ 371 Date: May 7, 2013

Related U.S. Application Data
(60) Provisional application No. 61/371,759, filed on Aug. 9, 2010.
(60) Provisional application No. 61/439,953, filed on Feb. 7, 2011.

(51) Int. Cl. A63F 13/06

(52) U.S. Cl. CPC A63F 13/06
USPC 463/31; 463/37

(57) ABSTRACT

A universal gaming controller and method for enabling connectivity between at least one physical host and at least one electronic device is disclosed. The physical host having at least one physical trigger configured to be operated by at least one user, thereby generating trigger-data, the electronic device having at least one port capable of receiving data and capable of being controlled by at least one user. The controller comprises a housing configured to be physically coupled with the physical host and the electronic device, and a connector configured to allow trigger-data transfer between at least one physical trigger of the coupled physical host and at least one port of the coupled electronic device, whereby the trigger-data is transferred to the electronic device via said at least one port.

### FIELD OF THE INVENTION

The present invention relates to gaming environments. In particular, the invention relates to creating mobile gaming platforms capable of being integrated with real-life elements and environments.

### BACKGROUND

Computer games can range from simple, single-player, text-based games to games incorporating complex graphics and virtual worlds populated by many players simultaneously.

Online computer games are generally played over online networks, typically the internet. Many online games have associated online communities, making online games a form of social activity beyond single player games.

Multiplayer online games have been made feasible by the growth of broadband internet access in developed countries, allowing thousands of players to play the same game together simultaneously. User interaction is often achieved through utilization of technologies such as instant messaging, video and audio streaming.

MUDs are one example of multi-user online games. MUDS are real-time virtual worlds (originally “Multi-User Dungeon”) which combine elements of role-playing games, interactive fiction, online chat and the like. Players can read or view depictions of rooms, objects, other players, non-player characters and actions taking place in a virtual world. Players can also interact with their virtual world environment and with each other.

Second Life (SL) is an internet-accessible virtual world, where real-world users can interact with each other as residents in the virtual world through avatars. Residents can explore, meet other residents, socialize, participate in individual and group activities, create and trade virtual property and services with one another, or travel throughout the virtual world. Software modeling tools enable virtual residents to build and create new virtual objects within that world.

Augmented reality (AR) is a field of computer research which deals with the combination of real world and computer generated data. At present, AR applications digitally process live video imagery and “augment” the imagery by adding computer generated graphics or information. Advanced AR applications include the use of data retrieved from a plurality of sensors and information sources such as the internet. The data is typically processed by complex technologies, such as motion tracking data, machine vision and machine learning, and presented to the user in various forms,

A practical AR use is the creation of virtual environments for simulating real-world situations, often targeted towards training an individual before he or she attempts to perform a complex or life-threatening task. Other uses include visual aids for displaying data related to consumer products, such as comparative data for canned goods placed on a supermarket shelf.

Thus far, applications of combining multiplayer online gaming and AR are relatively scarce. MUDs and Second Life are purely virtual, run from users' consoles and not associated with real-life objects. Simulation environments use data from real-life objects, but the environment is typically pre-defined.

In addition, today there are no known dedicated peripherals, for applications such as for gaming and simulations, for portable electronic devices such as smartphones and portable media players, whereas there's an abundance of gaming peripherals for immobile gaming consoles.

The present invention provides for these unmet needs.

### SUMMARY OF THE INVENTION

A universal gaming controller is disclosed, for enabling connectivity between at least one physical host hewing at least one physical trigger configured to be operated by at least one user, thereby generating trigger-data, and at least one electronic device having at least one port capable of receiving data and capable of being controlled by at least one user.

The controller comprises a housing configured to be physically coupled with at feast one of the physical hosts and at least one of the electronic devices, and a connector configured to allow trigger-data transfer between at least one physical trigger of the coupled physical hosts and at least one port of the coupled electronic devices, whereby the trigger-data is transferred to the electronic device the port.

In some embodiments, the controller further comprises an exchange unit configured to allow transfer of feedback-commands between the physically coupled electronic devices and the connector, in some embodiments, the exchange unit further comprises a command and control unit configured to allow generating impacts upon the physically coupled physical hosts according to feedback-commands received from the physically coupled electronic devices.

In some embodiments, the exchange unit is further configured to enable communication between the electronic devices and at least one gaming-server, and the gaming server is capable of receiving user-game-data generated by the controller, sending game-field-data to the electronic devices, and sending feedback-commands to the controller via the electronic devices. Optionally, the gaming-servers are configured to process game-field-data received from multiple sources info an augmented-reality platform. Optionally, game-field data comprises static-game-field-data and dynamic-game-field-data.

In some embodiments, the universal gaming controller is configured to be retrofitted upon the physical hosts. Optionally, the physical hosts can be hand-held.

In some embodiments, the impact is selected from a group comprising: visual impact, audial impact, tactile impact and olfactory impact.

In some embodiments, the port that is capable of receiving data is a port of available electronic devices. Optionally, the port is selected from a group comprising microphone ports, cameras, buttons, touch screens, blue-tooth ports, and WiFi ports.

In some embodiments, the electronic devices are each independently selected from a group comprising smart-phones, PDAs, portable gaming devices, portable media players and portable gaming consoles. In some embodiments, the physical host is selected from a group comprising toy guns, grenade launchers, missile launchers, steering wheels, wands, plush toys, board games and swords.

In some embodiments, the electronic devices each further comprise at least one data collection unit, the data collection unit configured to allow collecting data received from at least one physically coupled physical trigger and from at least one sensor. Optionally, the sensor is each independently selected from a group comprising GPS locators, gyroscopes, accelerometers, compasses, and tactile sensors.

In some embodiments, the controller further comprises an end-user output unit, in some embodiments, the electronic device further comprises an end-user output unit. Optionally, the end-user output unit is selected from a group comprising screens, loudspeakers, LEDs, illuminating components and vibratory components.

In some embodiments, the controller further comprises an end-user storage unit configured to store data aggregated by the data collection unit,

A gaming host is disclosed, the gaming host comprising: at least one physical trigger configured to be operated by at least one user and thereby generating trigger-data, a housing configured to be coupled with at least one electronic device having at least one port capable of receiving the trigger-data, at least one gaming controller configured to allow data transfer to the electronic device, and a connector configured to allow transfer of the trigger-data to the port.

A gaming platform generation method is disclosed, the method comprising: providing at least one universal gaming controller, a physical host having at least one physical trigger and an electronic device having at least one port capable of receiving data, the controller comprising: a housing physically coupled with the physical host and the electronic device, a connector configured to enable trigger-data transfer between at least one physical trigger and at least one port, and an exchange unit;

coupling the physical host with the electronic device, such that trigger-data can be received from the physical trigger by the port;

interpreting trigger-data consisting of physical actions performed by the user on the physical trigger;

transferring the trigger data to the electronic device via said the port; and

processing the data within the electronic device.

In some embodiments, physically coupling the physical host with the electronic device comprises providing housing for the electronic device, coupling the housing to the physical host, and placing the electronic device within the housing.

In some embodiments, the method further comprises sending user-game-data generated by the electronic device to at least one gaming server. In some embodiments, the method further comprises processing user-game-data and game-field-data received from at least one source into an augmented reality game-field. In some embodiments, the method further comprises sending game-field-data from the gaming server to the electronic device.

### BRIEF DESCRIPTION OF THE FIGURES

For a better understanding of the invention and to show how it may be carried into effect, reference will now be made, purely by way of example, to the accompanying drawings.

With specific reference now to the drawing in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawing making apparent to those skilled in the art how the several forms of the invention may be embodied in practice.

In the accompanying drawings,

FIG. 1 is a schematic block diagram of an embodiment of an augmented

reality CAR) environment generation system;

FIG. 2 is a schematic block diagram of the components of an embodiment of a typical end user device used within an AR environment generation system;

FIG. 3 is a schematic block diagram of an embodiment of a central unit of an AR environment generation system;

FIG. 4 is an embodiment of an AR end-user device in the shape of a hand-held toy-gun;

FIG. 5 is a schematic block diagram of different sensors aggregated in bulks for measuring different physical attributes of an AR end-user device;

FIG. 6 illustrates an end user device communicating using a variety of communication technologies;

FIG. 7 illustrates an embodiment of a virtual firing range for a multi-user AR shooting game;

FIG. 8 illustrates a processor within a central unit computing shooting hits in a multi-user AR shooting game;

FIG. 9A is a block diagram of the essential components of a universal gaming controller;

FIG. 9B is a block diagram of components of a second embodiment of a universal gaming controller;

FIG. 9C is a block diagram of a plurality of gaming units interacting with each other via a shared server;

FIG. 10A illustrates an embodiment of special-purpose gun-shaped gaming instrument;

FIG. 10B illustrates a close-up view of an embodiment of a gun-shaped gaming instrument having a connection port;

FIG. 10C illustrates a close-up view of an embodiment of a gun-shaped gaming instrument and a gaming controller having a connection port for coupling to the gaming instrument;

FIG. 11A illustrates a front view of gun-shaped gaming instrument and a controller having a pressure clasp for clasping electronic devices;

FIG. 11B illustrates a cable connecting a gaming controller to an electronic device via a standard audio port;

FIG. 12A is a rear view of a toy-gun shaped special purpose gaming device embodiment comprising a light emitting mechanism:

FIG. 12B is a front view of a toy-gun shaped special purpose gaming device coupled with a controller holding a cellular phone, and further showing a camera lens of the cellular phone;

FIG. 13A illustrates an embodiment of a steering-wheel shaped special purpose gaming device;

FIG. 13B illustrates a second embodiment of a steering-wheel shaped special purpose gaming device; and

FIG. 13C illustrates a rear view of second embodiment of a steering-wheel shaped special purpose gaming device.

### DETAILED DESCRIPTION OF THE SELECTED EMBODIMENTS

Before explaining at least one embodiment of the invention in detail it is to be understood that the invention is not necessarily limited in its application to the details set forth in the following description or exemplified by the Examples. The invention is capable of other embodiments or of being practiced or carried out in various ways.

The terms “comprises”, “comprising”, “includes”, “including”, and “having” together with their conjugates mean “including but not limited to”.

The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

It is appreciated that certain features of the invention, which are, for clarify, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In discussion of the various figures described herein below, like numbers refer to like parts. The drawings are generally not to scale. For clarity, non-essential elements were omitted from some of the drawing.

Various embodiments of a mobile and portable gaming platform system and method are disclosed hereinbelow. The system is capable of dynamically generating Augmented Reality environments derived from multiple real-life objects and people and combined with virtual, computer generated elements. The system is configured to be integrated or retrofitted with real-life physical elements (such as but not limited to toy guns or gaming wheels). The system is further configured to track actions performed on the physical elements and report these actions to standard available digital equipment and electronic devices such as smartphones and personal digital assistants (PDAs). Communication is preferably done via standard ports of the electronic devices, for example audial ports.

The mobile gaming platform typically consists of at least one universal gaming controller. The gaming controller is used to enable connectivity and communication between physical elements serving as special purpose gaming instruments and suitable electronic devices such as but not limited to smart phones, multimedia devices and PDAs, in some embodiments, the electronic devices are capable of being hand-held. Communication is preferably enabled via standard built-in jacks/ports, thus eliminating the need in dedicated ports for connectivity. The universal gaming controller enables a single user or a plurality of users to engage in gaming scenarios powered by applications installed on their electronic devices, regardless the types of electronic devices they possess. The special purpose gaming instrument typically serves as a host for the controller and an electronic device.

The universal gaming controller is capable of transferring data about physical actions performed by a user on special-purpose gaming instruments to standard electronic equipment. Examples of special-purpose gaming instruments may be toy guns for shooting games, steering wheels for driving games or the like. Examples of physical actions performed by a user are pressing buttons, pushing a toy gun trigger, and steering a wheel clockwise or counterclockwise. Examples of suitable electronic devices are smart phones and PDAs.

Optionally, the universal gaming controller is further capable of aggregating data regarding the mobility and operation of physical special-purpose gaming instruments and transferring this data to standard electronic devices. Universal gaming controllers may be integrated with or configured to be coupled to special-purpose gaming instruments.

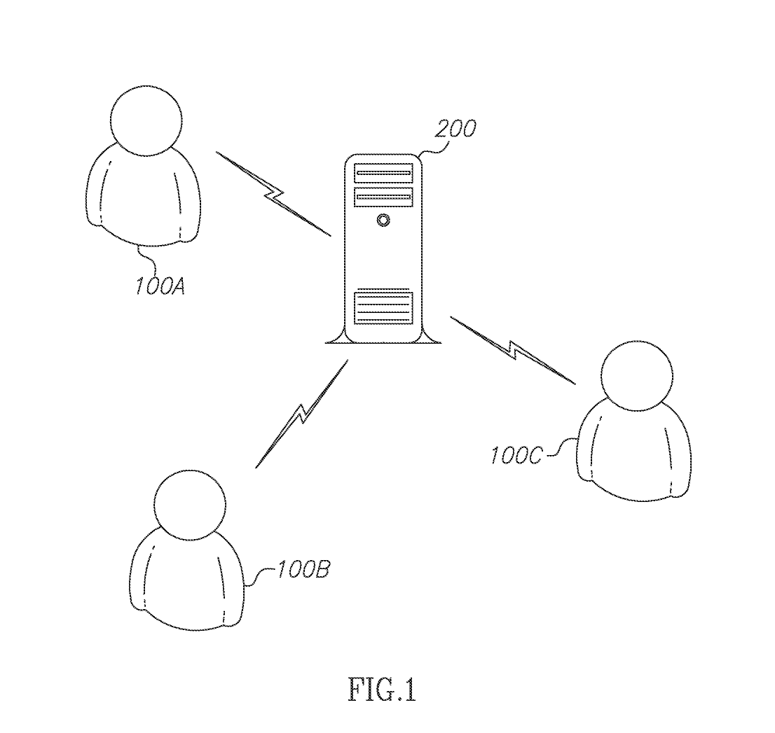

In some embodiments, the mobile gaming platform further employs an augmented reality (AR) platform generation component comprising a plurality of end-user digital equipment/electronic devices capable of communicating with a central unit (as seen in FIG. 1) and optionally directly with each other. Each end-user device comprises at least one sensor, an end-user data collection component, an end-user communication component, an end-user processor, an optional end-user output component and an optional end-user storage component. Each central unit typically comprises at least one central storage, at least one central communication component, and at least one central processor.

For the purpose of clarity, “real life objects/parameters” refer to physical objects and physical attributes of the real world, and “virtual objects” refer to generated objects which may not be directly linked to physical objects and attributes. Augmented reality refers to the combination of real life and virtual objects and parameters into a new reality.

“Physical hosts” are typically toy objects capable of being operated by a user, toy objects such as toy guns, wheels, wands or the like. Physical hosts comprise at least one physical trigger which users can operate in different ways. Physical triggers may vary in shape, size and mode of operation and include, for example and without limitation, gun-like triggers, push buttons, turn buttons, pull/push handles, and revolving elements.

When integrated with a universal gaming controller, physical hosts are capable of generating “trigger data”. When a user operates a trigger on a physical host, data regarding the user action is interpreted into “trigger-data” which can be transmitted by the controller to an external pod on an electronic device.

“Feedback-commands” may be transmitted between the electronic device and the controller. “Feedback-commands” may include data regarding visual audial, tactile or scent feedback which may be transmitted to a user during the game. Transmittal of the feedback commands may be targeted towards the electronic device or towards the physical host. Feedback commands are used to generate an impact on the user via the electronic device or via the physical host. For example and without limitation, visual feedback commands may include data regarding an image which should be displayed on a screen of an electronic device; audial feedback commands may include generating a sound via an electronic device; tactile feedback commands may include generating an electric current or a vibration in the physical host, such that it can be felt by the user's body part which is in physical contact with the physical host, for example a shake representing a repulsion effect felt in the handle of a toy gun held by a hand of a user; and a olfactory feedback command may trigger a release of an odor-distributing element stored within the physical host.

For the purpose of illustration and as a non-limiting example, the system will be demonstrated via a particular example of a gaming platform which emulates life-like ballistics where players engage in launching virtual objects and also serve as moving targets for the objects in the game.

Gaming Platform

Reference is hereby made to FIG. 1 illustrating a schematic block diagram of an embodiment of the system comprising 3 end-users 100A, 100B, 100C holding communication devices/electronic devices (shown in another figure as end-user device 100), wherein the end-use devices are in communication with a gaming server 200 serving as a central unit. In other embodiments, a different number of end-user electronic devices and gaming servers may be used, in different communication topologies.

The end user devices are capable of generating user-game-data to be transmitted to the gaming server. User-game-data may consist of information recorded per specific end user, for example trigger data, data collected by different sensors, or data processed by the electronic device.

The gaming server is configured to generate and send game-field-data to end-user electronic devices and optionally to other servers. Game-field-data typically consists of raw data received from multiple sources. The raw data may contain static and dynamic game field data which will be described in detail below. The raw data can be processed into definitions of an augmented-reality game-field. Raw data may be received automatically or entered manually by a user, for example a gaming administrator in control of the game-field.

### End-User Devices

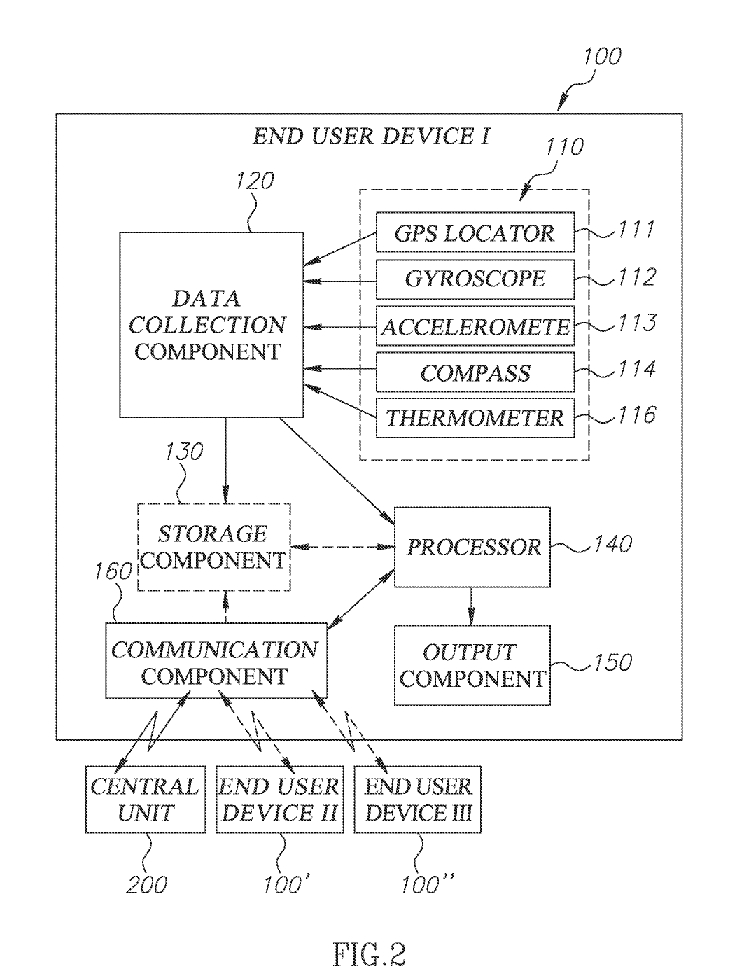

Reference is hereby made to FIG. 2 illustrating a schematic block diagram of the components of an embodiment of a typical end-user device 100 for AR platform generation systems. Each of the end-user devices 100 comprises a plurality of sensors 110 for detecting and measuring the physical orientation of the device. Examples of such sensors are a GPS locator 111, a gyroscope 112, an accelerometer 113, a compass 114 or the like, Each device may further comprise sensors, such as a microphone, a thermometer 116, a hydrometer or the like for detecting other physical characteristics.

In the embodiment shown in FIG. 2, data from the sensors is collected by an end user data collection unit 120 (may also be referred to as ‘data collection component’ 120), and may be stored in an optional end user storage unit 130 (may also be referred to as ‘storage component’ 130). The data collected from the sensors, along with trigger-data representing actions performed on a physical trigger located on a physical host, is typically sent to an end user processor 140 An end user communication unit 180 (may also be referred to as ‘communication component’ 160) is configured to allow receipt of data therein from a central unit 200 and possibly from other end user devices 100′, 100″, and to send that data to the processor 140 and optionally to the storage unit 130. The processor 140 may be configured to allow retrieval therein of data stored in the optional storage unit 130. The processor 140 processes the data received from the data collection unit 120, from the communication unit 160 and from the storage unit 130 and sends processed results to an end user output unit 150 (may also be referred to as ‘output component’ 150) in communication with a user (not shown).

The end user processor 140 may further send processed results as data to the end user communication unit 160, The communication unit 180 may be configured to transmit that data to the central unit 200 and optionally to other end-user devices 100′, 100″. It is noted that communication between the end-user devices may be through the server or direct peer-to-peer communication, and may use a variety of dispatching and broadcasting protocols.

Typically, end-user devices for AR platform generation systems are configured to be carried by a user. The device may he autonomous or coupled with another device, such as but not limited to a cell-phone or a PDA. The device may also be coupled with or integrated with typically non-electronic articles such as but not limited to balls, bats, model guns or the like.

Central Unit

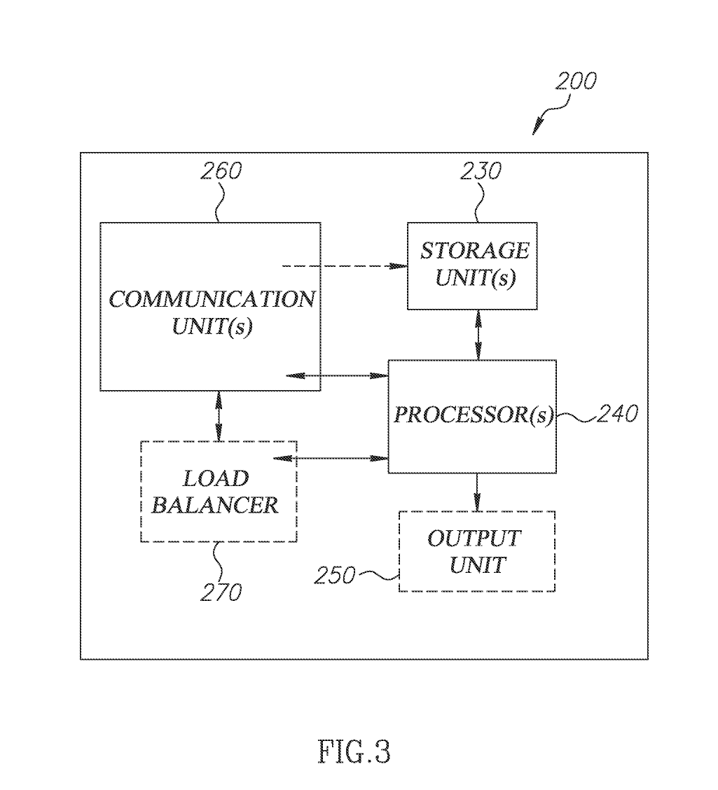

Reference is hereby made to FIG. 3 illustrating a schematic block diagram of a central unit 200 comprising at least one central storage unit 230, at least one central processor 240, at least one central communication unit 260 and optionally one or more central output units 250.

The central storage unit 230 typically comprises a database configured to store data received by the central communication unit 260 from a plurality of external end-user devices, and processed data from the central processor 240. The processor 240 processes dais received from the communication unit 280 and the storage unit 230, and sends the processed data to the communication unit 260 for distribution to the end-user devices such as described in FIG. 2. The processor 240 may optionally send processed data to a central output unit 250. The central unit 200 may further comprise a load balancer 270 used for example and without limitation for balancing the processing load between a plurality of processors 240, balancing storage of information among a plurality of storage components and balancing the communication load between a number of communication components 260.

### Shooting Game Example

For the purpose of illustration only, an exemplary AR platform generation system will now be described in detail through a specific example of a multi-participant shooting game. The game is typically played by participants having electronic devices integrated or coupled with embodiments of AR end-user devices 100 such as described in FIG. 2. Alternatively, the game may be played with a hand-held auxiliary instrument, such as a toy gun or the like, which may he integrated or coupled with the AR end-user device 100 such as described in FIG. 2.

Game-field-data will foe referred to herein as the combination of static-game-field-data and dynamic-game-field-data. Static game field data typically consists of data regarding static physical objects in the AR game field. Static objects may be walls, roads, scenery elements such as mountains and lakes, non-moving plants such as trees and bushes, or even moveable objects such as tables and chairs.

Static game-field-data may consist of data such as but not limited to physical attributes of static objects comprising a game-field. Attributes may include objects' size and shape if represented as two dimensional elements, and elevation data such as height and depth when presented as three-dimensional elements. Dynamic game-field-data may consist of data regarding the dynamic objects in the play field, typically data regarding the players participating in the game. Data about players may include their position within the game-field, for example absolute or relative physical coordinates within the game-field. Data about players may also include their “life span” in the game, ammunition, scoring or the like.

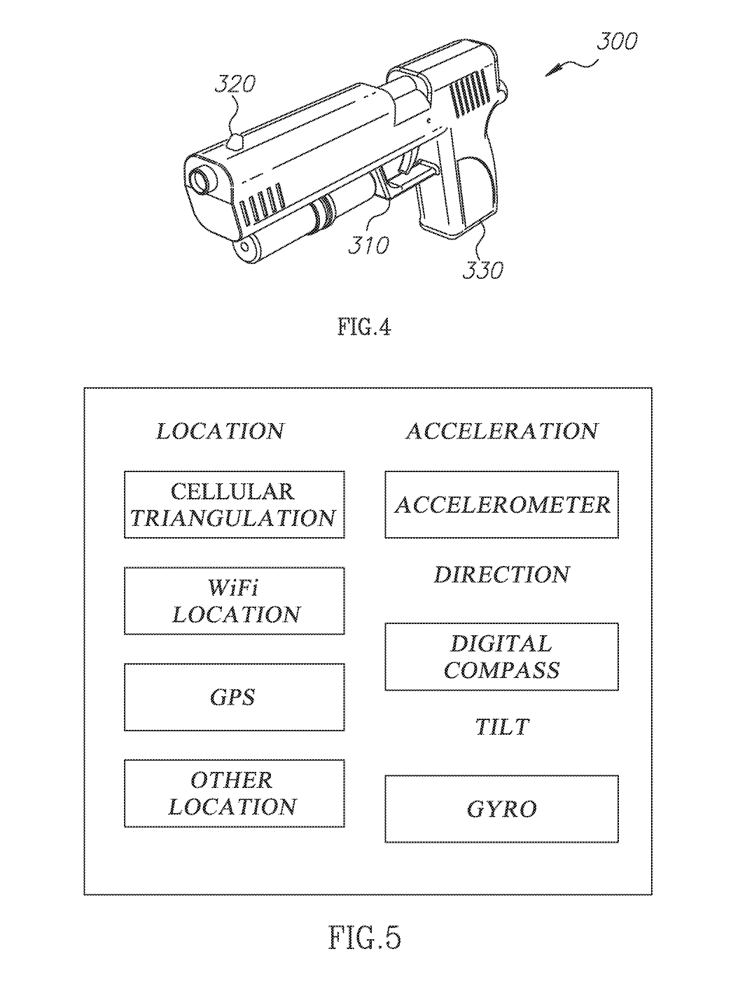

Reference is now made to FIG. 4 illustrating an embodiment of an AR auxiliary instrument 300 in the shape of a hand-held toy-gun. The AR auxiliary instrument 300 is adapted to be coupled with an AR end-user device (not shown in this figure). The toy-gun shaped AR auxiliary instrument comprises a trigger 310, a barrel 320, and a handle 330. Data regarding AR auxiliary instrument 300 is detected and collected by the associated AR end-user device.

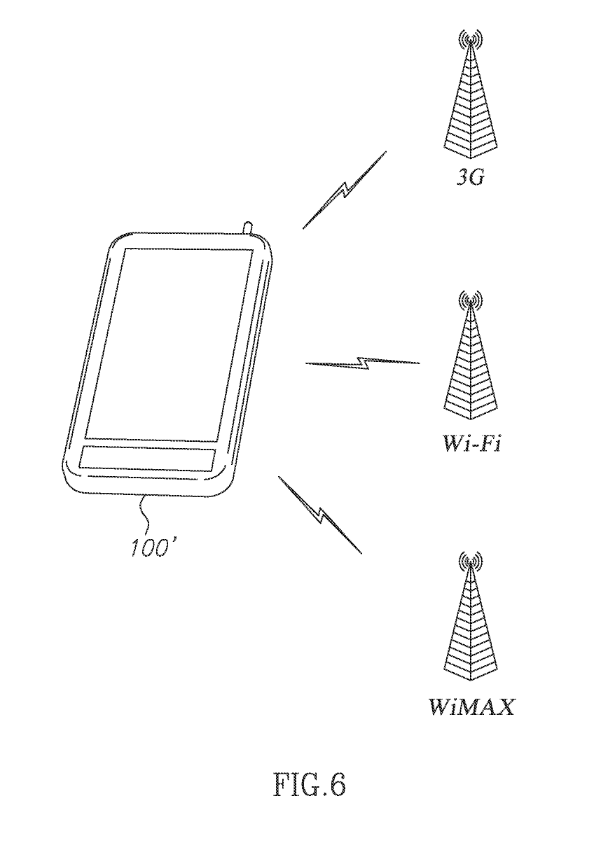

Reference is hereby made to FIG. 5 illustrating a schematic block diagram of different sensors aggregated in bulks for measuring different physical attributes of an end user device. In this embodiment, the sensors are bulked according to location, acceleration, direction and tilt. Other embodiments may comprise other sensors and be bulked according to different criteria to suit specific needs.

Users in the game are typically registered with a server (such as 200 of FIG. 3) to determine a user-based playfield. Typically, a user would hold at least one end-user device. Once registered, data from the AR end-user device is collected. The data can contain, for example and without limitation, processed information about the location of the AR auxiliary instrument in the playfield, its orientation, the direction in which the barrel (320 of FIG. 4) is pointing and whether the trigger (310 of FIG. 4) has been pulled.

FIG. 6 illustrates how the data may be collected. The figure illustrates a single end user device 100′ receiving information for example from a plurality of space-based global navigation satellite systems. The device 100′ may transmit the acquired data to a central unit (such as 200 of FIG. 3) or to other end user devices. Optionally, central unit may be hosted by one of the end user devices itself. Alternatively, a plurality of end user devices may be configured to communicate with each other to form a network without a central unit.

This data may be continuously collected and transmitted to a central unit (such as 200 of FIG. 3). The transmission process may be continuously or periodically performed, simultaneously as data is being received, or in a delayed transmission optionally comprising bulks of information accumulated by the device over a time interval. Each data transmission may contain the full state of the client, or only the difference between the previously transmitted data and the new data. Alternatively, only partial data may be sent. Data may optionally be in a pre-processed form, wherein the pre-processing can take place on the end user device itself.

Referring back to FIG. 3, data from multiple end user devices is typically received by the communication unit 260, aggregated in the storage unit 230 and processed by the central unit's processor 240. Processed data is then sent back to each of the end user devices. The processed data typically contains information relevant to all the end user devices, such as the different end user devices' location within the playfield at a certain moment. That data may be broadcasted to all the registered end user devices in the game.

Data regarding a specific end user device is typically sent from the central unit directly to that end user device. In some embodiments, end user devices may be capable of peer-to-peer communication to transfer data directly to each other (not via the server).

Data aggregation and processing within the central unit is analyzed into a multi-user play field. The central unit may contain information about the number of end-user devices, their physical location within a playfield, the direction in which end-user devices are pointing, and whether attempts have been made by certain end-user devices to shoot other end user devices in their play field in addition, the central unit may process and analyze information received to generate a central unit model of the game. Such a central unit model may then be further processed info a plurality of individual end user devices' perspectives, grouped perspectives or such like. These perspectives may be sent to individual devices.

Data aggregation and processing can take place within each end-user device, or on a central server. Data typically includes information about the playfield and actions happening within the play-field which are relevant to the game. This may be demonstrated by reference to a specific example of a “shoot and hit” computation, where a “shooting” action may be defined as the state in which a participant pulled the trigger on the auxiliary instrument, and “hitting” may be defined as the state in which a shooting occurrence was triggered by one auxiliary instrument pointing directly at another auxiliary instrument. In other embodiments, “hitting” may be defined as “pressing a dedicated area on a touch screen” belonging to an electronic end-user device such as but not limited to a smartphone.

The processor within an end-user device may use information sent by a central server regarding the state of the playfield to calculate whether the auxiliary instrument triggered an action that generated a hit that affects other auxiliary instruments in the playfield. Alternatively, “hits” may be processed centrally according to information received from a plurality of end user devices.

Examples of parameters that may be processed from the information aggregated from the different end-user devices include the following:
The number of participants (end user devices) in a game;
The types of end-user devices participating in the game;
The speed at which each end-user device is moving;
The direction in which each end-user device is pointing;
Record of shooting occurrences, when a physical or virtual trigger on an end-user device is pressed (physical trigger typically belonging to an auxiliary real-life physical element such as a toy gun or a toy wheel, and virtual trigger typically in the form of a button optionally displayed on a screen of an end-user device);
Record of hits, when one end user device generated a shooting occurrence directed towards another end-user device;
Temperature at end user devices' location;
Altitudes of end user devices;
Distance of an end-user device from static objects and platforms such as the floor or walls;
Distance of end user devices from dynamic objects such as other end-user devices in the game;
Processed image information captured by cameras;
GPS, DGPS, AGPS and other positioning coordinates; and
Angular positioning of each end-user device within a plain.
   Parameters may relate to pre-defined objects or dynamic objects according to requirements.

### Sample Usage and Algorithms

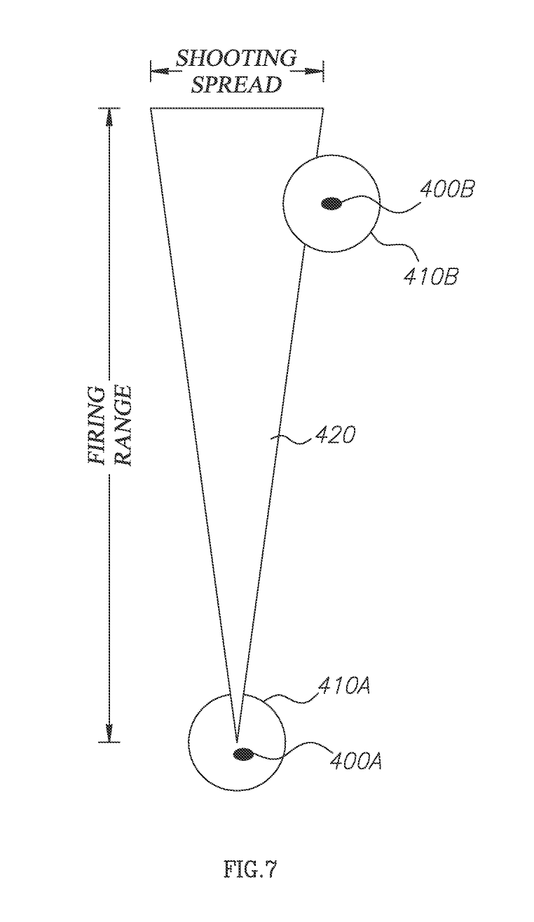

Reference is hereby made to FIG. 7 illustrating an embodiment of a virtual firing range that may be used in the multi-user AR shooting game. Two players 400A and 400B are each associated with an end-user device (the end-user device is not shown). In the figure, each player is represented by a target-circle 410A, 410B that represent a location of the end-user device with an optional error radius.

A cone 420 extends from player 400A acting as the shooter indicating the shooting range and the shooting spread of the hand held end-user device associated with the player 400A. The direction may be acquired using a compass, a gyroscope or other direction monitoring mechanism. The algorithm finds the intersection of the triangle 420 with other players' target circle 410B or if some circles are within the triangle itself, thus deciding whether a “hit” has been made.

The ballistic model described above is simplified to relate to the shooting of fast moving projectiles towards targets. Accordingly, the simplified model may approximate the trajectory of a projectile as a straight line, and the time of strike to be almost simultaneous with the pulling of the trigger. Alternative models may be provided for virtual ball games and the like, wherein physical models may be used to more realistically model the typically parabolic motion of the projectile and the extended duration of the travel. Various ballistic models are known that may be used to model behavior of the projectiles including simple Newtonian models and complex models including correction for wind speed and the like. Parameters used in the calculations for such models may be taken from measured values of real environment, may be virtually generated as part of the augmented environment or may be combinations thereof.

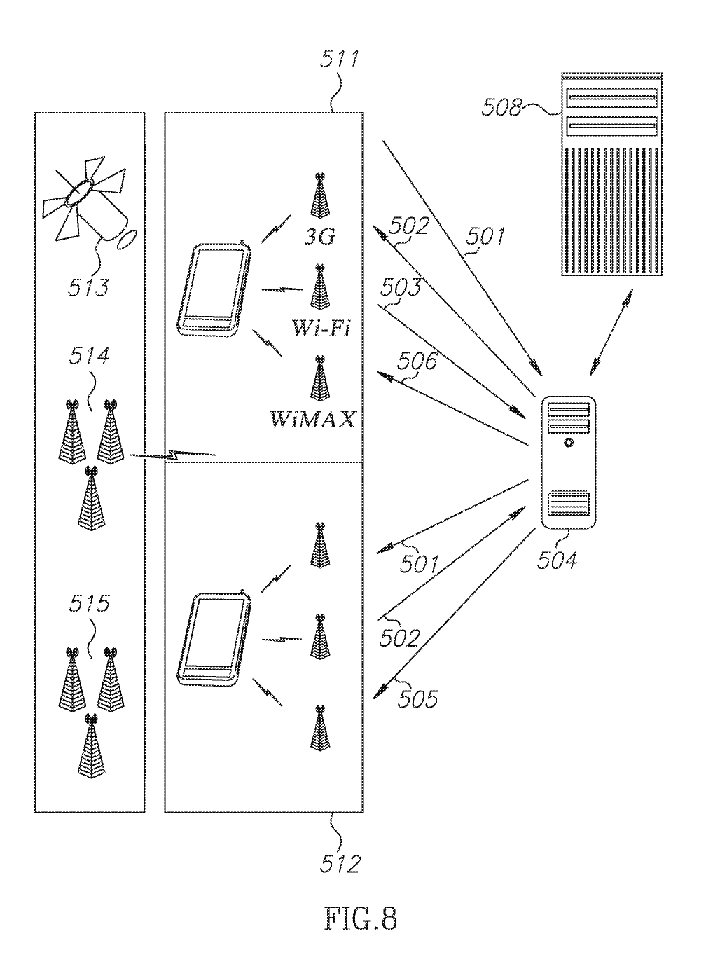

Reference is now made to FIG. 8 illustrating an electronic end-user device 504 in communication with a central server 508, if should be noted that server 508 may represent a communication endpoint of a cluster of servers, the server cluster typically configured for high availability and load balancing. Electronic end-user device 504 may also receive data from other end-user devices 511 and 512. End-user devices 511 and 512 demonstrate communication capabilities via a plurality of technologies such as but not limited to 3G cellular connectivity; VViFi and WiMax. Data from end-user devices can be further transferred to central communication devices such as a satellite 513 or land antennas 514 and 515. Direct and indirect (proxy) communication between end-user devices 504, 511 and 512 may thereby be enabled. Communication may be:
Bidirectional communication: data transfer 501 from end-user device 511 to end-user device 512 via end-user device 504, and data transfer 602 from end-user device 512 to end-user device 511 via end-user device 504.
Unidirectional communication; data transfer 503 from end-user device 511 to 504.
Selective broadcast communication: data transfer 508 from end-user device 504 to a plurality of end-user devices (the plurality not shown) comprising device 511 but not end-user device 512, and from end-user device 604 to a plurality of end-user devices (the plurality not shown) comprising device 512.
Full broadcast communication (not shown).

A processor within a central unit (server 508) may compute shooting hits in the game. Alternatively, the hits relevant to a specific end-user device can be computed by the processor on the end-user devices 504, 511 or 512 themselves. Communication between end-user devices and the central unit may be provided over an internet connection, using cellular connection, Wi-Fi, WiMAX or other available connectivity means, as well as combinations and sub-combinations of connectivity means.

### Output/Data Display

Each end-user device is typically equipped with an output unit configured to display data to the user. Output may be visual, for example a screen display of the data received from the central unit regarding the mapping of the AR playfield and the end-user devices (representing participants) therein. Additionally and alternatively, the display may comprise audial outputs, for example and without limitation music, sound effects symbolizing a hit or the like. Tactile outputs may comprise vibrations of the toy-gun handle simulating the recoil effect typically caused when a gun is fired.

The output unit (such as output unit 250 in FIG. 3) of an end-user device may be used to display to a participant various features including:
The AR playfield as received from the central unit;
The AR playfield with additional data as calculated by the end-user device's processor;
Information about the end-user's device state, such as but not limited to the state of its ammunition, scoring, energy levels or the like;
Information regarding the positioning of the end-user device and end-participants in the game, for example a virtual display of the participant that the end-user device is pointing to;
Information regarding the absolute positioning of the end-user device in a playfield, optionally presented as the position of the end-user device on a map (a city map, a building construction plan or the like);
Augmented images of other players;
Game state (number of players, player statuses, teams and etc); and
Particular user information such as but not limited to the virtual health status of other players;
AR images/animations of virtual players/objects (optionally displayed in a multidimensional form, for example a 3-d hologram).

The output unit of an end-user device may further be used to allow communication between participants. The output unit may be used to display messages sent from other users or from the central unit. Messages may be visual, tactile, audial or any combination thereof. Messages may include text, voice messages, video messages or the like, and may be sent using a variety of streaming protocols commonly used for communication such as hut not limited to VOIP (Voice Over internet Protocol),

Additionally, data collected and processed in the central unit may be displayed in an optional output unit, offering an overall view of the playfield and the participants in a single gaming session.

A common AR game field may be displayed to a plurality of participants in the game, and specific end-user data may be appended to the display, such that each end-user output unit presents both user-specific and common game data.

### Variations and Additional Embodiments

Although the playfield for the game is computed by the central unit, it may be based on real-life parameters obtained by end-user devices related to physical traits of users such as location, speed, direction and the like. The gaming environment is a virtual augmented reality platform based on the real data collected by the end-user devices and the central units interpretation of that data.

More end-user devices may be tagged or coupled with generally static objects such as walls, frees, furniture or the like. Data reported from these devices may also be used to alter the gaming environment. For example, when a piece of furniture is moved from one location to another, it is reflected in the gaming environment.

Accordingly, the playfield definition based on reality may change as reality changes. This is in contrast to the prior art where the gaming environment is pre-defined and not altered as a response to real-life events. The construction of the playfield, or the construction of any other controlled AR environment may be based on multiple sensors and actuators. Fiducial marker recognition using machine vision, for example, and machine learning can be put to use in the construction of the controlled environment.

In some embodiments, separate sets of players may participate in different augmented reality scenarios while located in the same physical space. One group of participants may be unaware of another group residing in the same physical space but playing a different game. Alternatively, in other embodiments, players may be physically apart from each other, and still participate in the same scenario in the same playfield.

It is not obligatory for ail end-user devices to share the same configuration. The multi-user shooting game, for example, may be played by standalone end-user devices, end-user devices coupled with auxiliary instruments such as toy guns, toy rifles, and other pointing devices, sports devices, or alternatively integrated into electronic devices such as cell phones or PDAs.

Multiple end user devices may be used by a single participant, or alternatively a single end-user device can be used to represent a plurality of objects. Such is the case with another application of the AR platform generation system for creating a virtual food fight. A single end-user device can be used to simulate a dozen eggs, for example.

For the purpose of illustration, more applications of the system comprising different elements are disclosed herein;
Sports games or simulations targeted towards exertion measurements, wherein the system uses parameters such as distance, pulse, humidify, temperature, air pressure or the like to generate elements within the AR environment.
Sword games—the end-user device simulates a sword by using a mass-sensitive sensor (optionally an accelerometer) for obtaining measurements about the position and movement of the device. Two players may play against each other by exchanging end-user device information, either directly or via a central unit.
An image processing based road-sign simulation, wherein the participants' goal is to pick-up or shoot road signs. Different scores may be provided for different road signs. This game could be useful for distracting young kids during exhausting road trips.

The system may further utilize artificial intelligence (AI) and AR marker based elements. Virtual targets may be combined info various gaming and training scenarios. For example, the shooting game may add virtual targets. Such virtual targets may be for example and without limitation:
Popping out of static real-life elements such as billboards, road signs or the like;
Static targets;
Moving targets;
Targets with fixed characteristics such as size, mobility, hostility or the like; and
Targets which change their shape, form, appearance or the like, optionally in response to occurrences in the game,

More sensors for obtaining environmental data that may serve as input for the AR environment may be included in certain systems. Sensors such as a pulsometer may be used to obtain data about the user, and other sensors may be used to obtain data about the environment. Such sensors may include one or more of pulsometers, hygrometers, pressure gauges, a wind gauges (anemometers), thermometers, microphones, cameras, sensors for measuring light intensity, accelerometers, compasses, GPS locators, gyroscopes or other sensors according to need.

Display units within end-user devices refer to multiple types outputs, including visual, audial and tactile outputs. Visual output may be in the form of texts, pictures, graphical indications, videos, lights or the like. Audial output may comprise special sound effects, voice from other players or the like. Tactile output may be for example and without limitation in the form of vibrations.

Interfaces between gaming devices and the end-user devices in various embodiments are described in fuller detail below.

### Universal Gaming Controller Embedded Within End-User Devices

End-user devices comprise a universal gaming controller system and a method for connecting physical hosts (AKA special purpose gaming instruments or auxiliary instruments) to standard digital equipment Various universal gaming controller embodiments are disclosed hereinbelow.

Embodiments of a universal gaming controller enable connectivity of special purpose gaming instruments to standard, hand held electronic end-user devices such as but not limited to smart phones, multimedia devices and PDAs via standard built-in jacks/ports, thus eliminating the need in dedicated ports for connectivity. The universal gaming controller may enable a single user or a plurality of users to engage in gaming scenarios powered by software applications installed on their end user devices, with various types of electronic or communication devices they possess. The special purpose gaming instrument typically serves as a host for the controller and/or an electronic end user device.

The universal gaming controller is capable of transferring data about physical actions performed by a user on special-purpose gaming instruments to standard electronic equipment. Examples of special-purpose gaming instruments may be toy guns for shooting games, steering wheels for driving games or the like. Examples of physical actions performed by a user may be pressing buttons, pushing a toy gun trigger, and steering a wheel clockwise or counterclockwise. Examples of standard electronic devices may be smart phones and PDAs.

Optionally, the universal gaming controller is further capable of aggregating data regarding the mobility and operation of physical special-purpose gaming instruments and transferring this data to standard electronic devices. Universal gaming controllers may be integrated with or configured to be coupled to special-purpose gaming instruments. Data aggregation may be performed by sensors integrated within or retrofitted onto universal gaming controllers, electronic devices or the special-purpose gaming instruments.

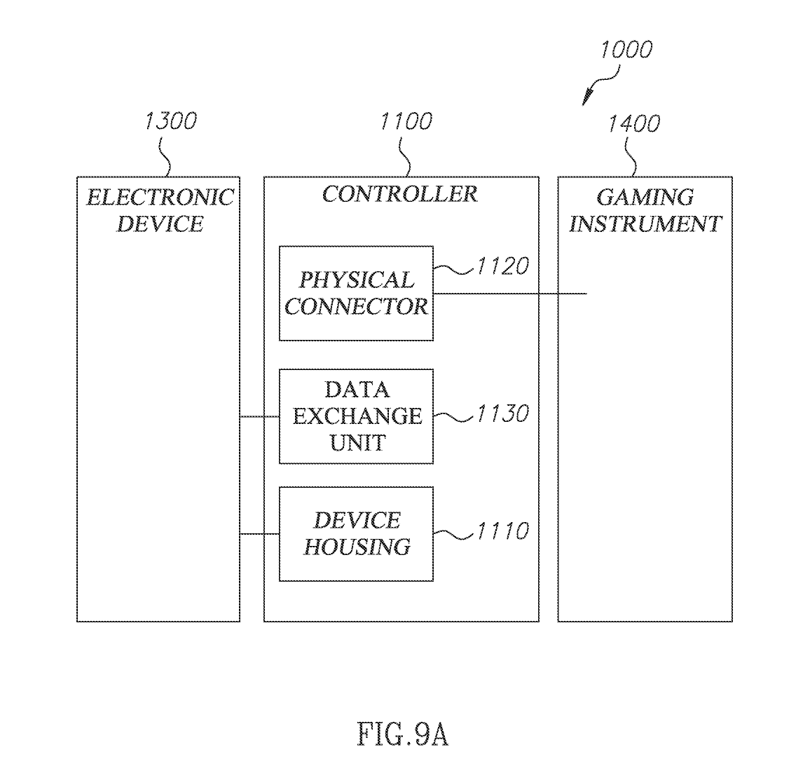

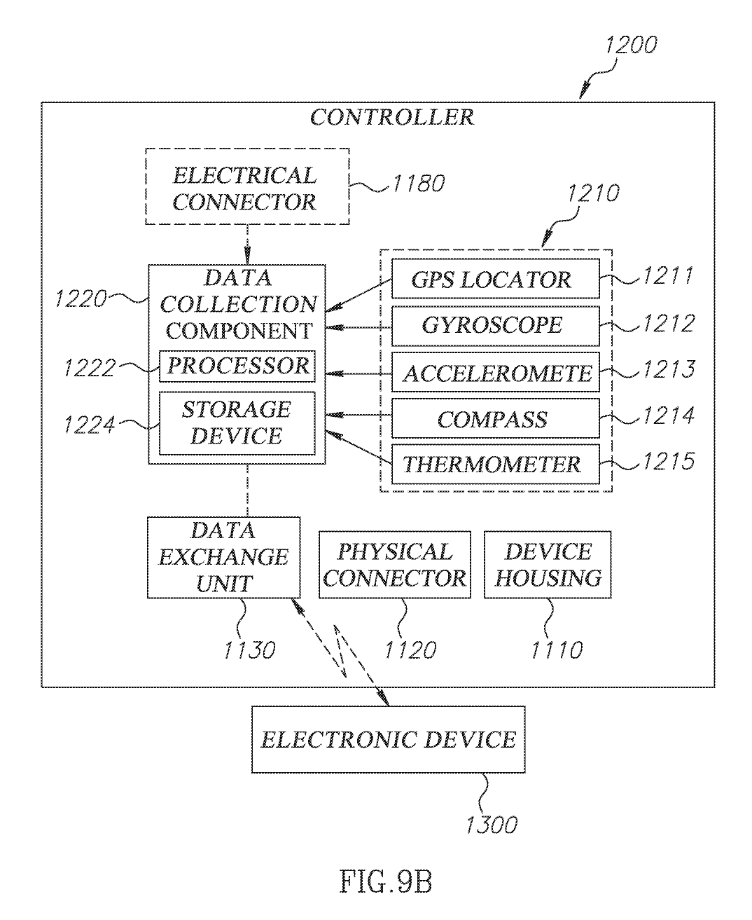

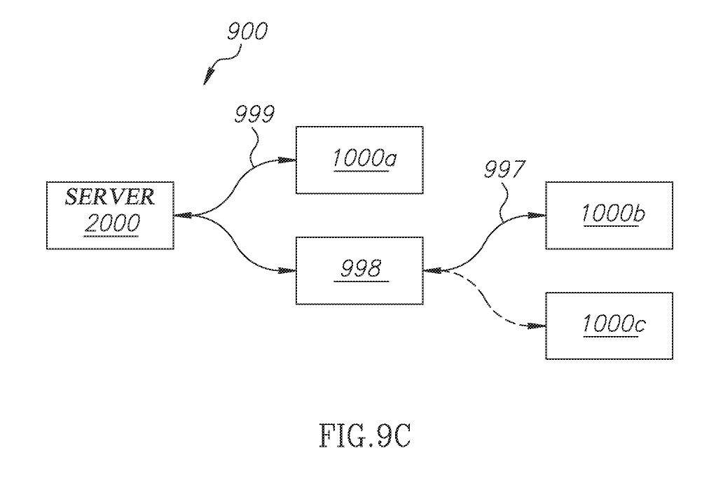

Reference is now made to FIG. 9A illustrating a block diagram of the essential components of a gaming unit 1000. Gaming unit 1000 comprises a gaming instrument (auxiliary instrument) 1400, a hand held electronic end-user device 1300 and a universal gaming controller 1100 interfacing between the gaming instrument 1400 and the hand held electronic end-user device 1300. In the depicted embodiment, universal gaming controller 1100 comprises a housing 1110 configured to be physically attached to the end-user device 1300, a physical connector 1120 capable of establishing communication between a special-purpose gaming instrument 1400 and controller 1100, and a data exchange unit 1130 configured to transfer data to end-user device 1300 and optionally receive data from the end-user device 1300. Sending and receiving of data is preferably done via standard ports/jacks commonly found in end-user devices 1300. Data exchange unit 1130 may be unidirectional (transmission only, such as when connected to a microphone entrance of a cellular phone) or bi-directional (transceiver mode, such as when connected via a USB port to the device 1300).

Standard ports may be audial ports commonly used for microphone and headphone connection typically available on all phone types regardless of the manufacturer. This is in contrast to what certain companies and manufacturers may refer to as “standard ports”, when the original manufacturing company defines a port for connectivity on its dedicated devices that does not enable connectivity to physical or electronic elements made by a different manufacturer—unless the latter has engaged in a business transaction with the original manufacturing company.

Reference is now made to FIG. 9B illustrating a block diagram of the components of an exemplary embodiment 1200 of a universal gaming controller. In this embodiment, the universal gaming controller is further capable of aggregating data regarding the mobility and operation of a special-purpose gaming instrument 1400 using a sensor unit 1210 comprising a plurality of sensors, and a data collection unit 1220.

Sensor unit 1210 comprises a plurality of sensors capable of measuring data regarding physical traits of the controller 1200 hosted on the special-purpose gaming instrument (not shown in this figure) such as location, speed, rotation speed, linear and/or angular acceleration, pointing direction and the like, and environmental traits such as, but not limited to, air temperature and humidity. In the Figure, sensor unit 1210 includes a GPS locator 1211, a gyroscope 1212, an accelerometer 1213, a digital compass 1214, and a thermometer 1215. Other embodiments may include combinations and sub-combinations of the above mentioned sensors and others, such as, but not limited to, a hygrometer for measuring air humidity, pressure detection sensors for measuring tactile effects, or any other sensors which suit needs.

Data collection unit 1220 is configured to collect data from sensor unit 1210. Data collection unit may comprise a processor 1222 capable of processing and analyzing the collected data and a storage device 1224 capable of storing raw and/or processed data collected from the sensors. Data is then sent to the end-user device 1300 via data exchange unit 1130.

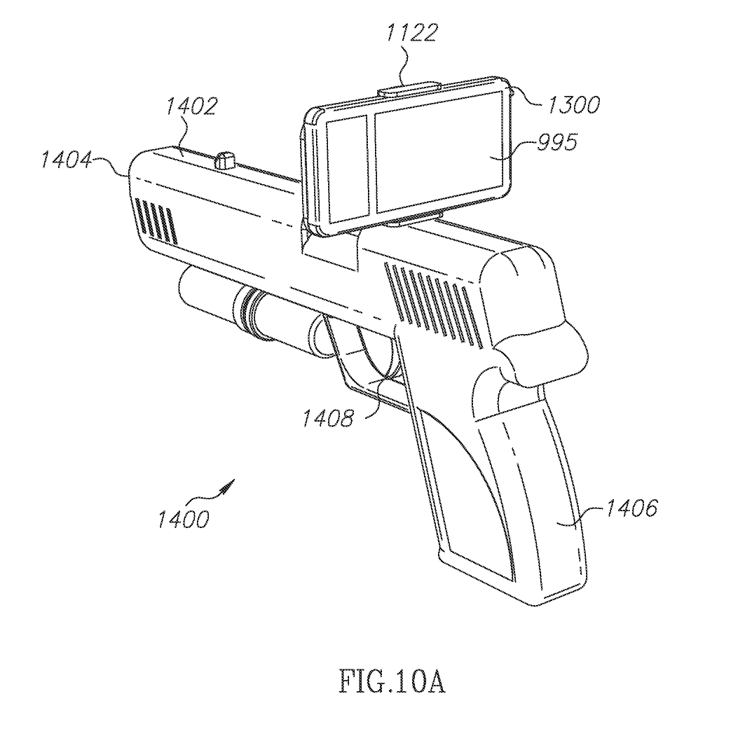

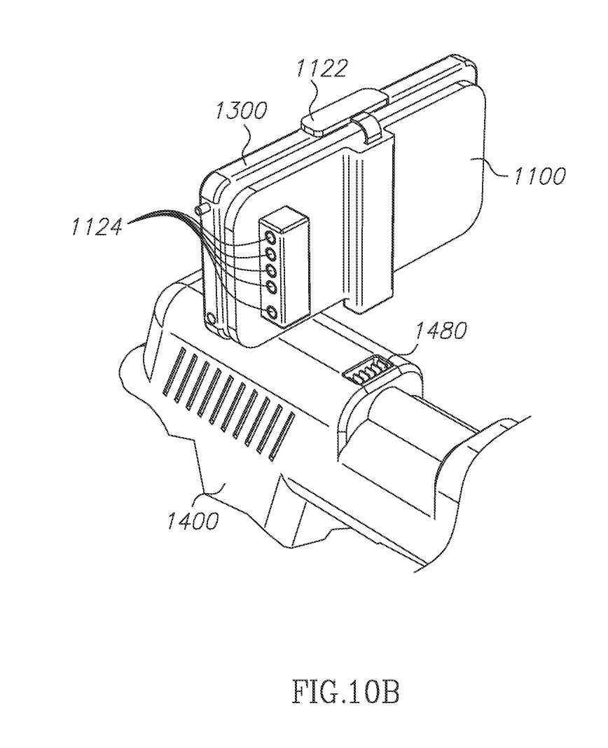

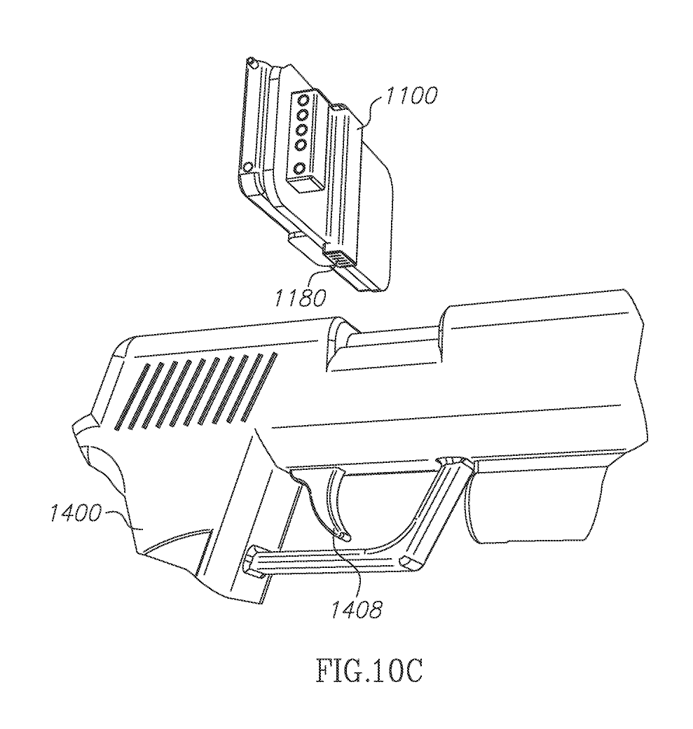

Reference is made to FIG. 10A illustrating an embodiment of special-purpose gaming instrument 1400. In this embodiment special-purpose gaming instrument 1400 is in the shape of a toy gun having a barrel 1402 with a muzzle 1404, a handle 1406 and a trigger 1408. In the figure, toy gun 1400 is integrated with or fitted with a controller (not seen in this figure) of which physical connector is for example in the form of a pressure clasp 1122 capable of clasping a standard end-user device 1300 such as a cellular phone provided with a screen 995 that can be viewed be the end-user. If should be noted that gaming instrument 1400 may house controller such as controller 1100 of FIG. 9A. Alternatively or additionally, the or controller may be an attachment attached to the gaming instrument 1400. It also should be noted that using several types of controllers, allows the same type of gaming instrument 1400 to be interfaced with different types of end-user devices 1300. The pressure clasp 1122 of controllers 1100 is preferably adapted to connect and hold a specific electronic device or a range of physically similar types of electronic devices. Alternatively, special-purpose gaming instruments may be connected with dedicated universal gaming controllers via special connection ports capable of transferring data from special-purpose gaming instruments to controllers.

Electrical connector 1180 (see FIG. 9B) is optionally used to transmit user action such as pulling a trigger, rotating a wheel or other user action or actions performed on the gaming instrument 1400 to the data collection unit 1220. Optionally, electrical connector 1180 is part of physical connector 1120. In some optional embodiments, electrical connector 1180 is optionally used to transmit signals to activate indicator such as an LED or a speaker (not seen in these figures) integrated into the gaming instrument 1400 for example to indicate a hit by a rival player, or other game related reactions.

FIGS. 10B and 10C illustrate how a controller 1100 holding an end-user device 1300 may he coupled to a special purpose gaming instrument in the shape of a toy gun 1400 via standard connection ports 1480 (on the toy gun in FIG. 10B) and 1180 (on the end-user device in FIG. 10C). Controller 1100 is shown having a clasp 1122 and a plurality of optional plugs 1124 for receiving different types of wires, for example wires connecting end-user device 1300 to the controller.

This sample connection ports are for illustration purposes only: other forms of connection ports and coupling means may be used which suit requirements.

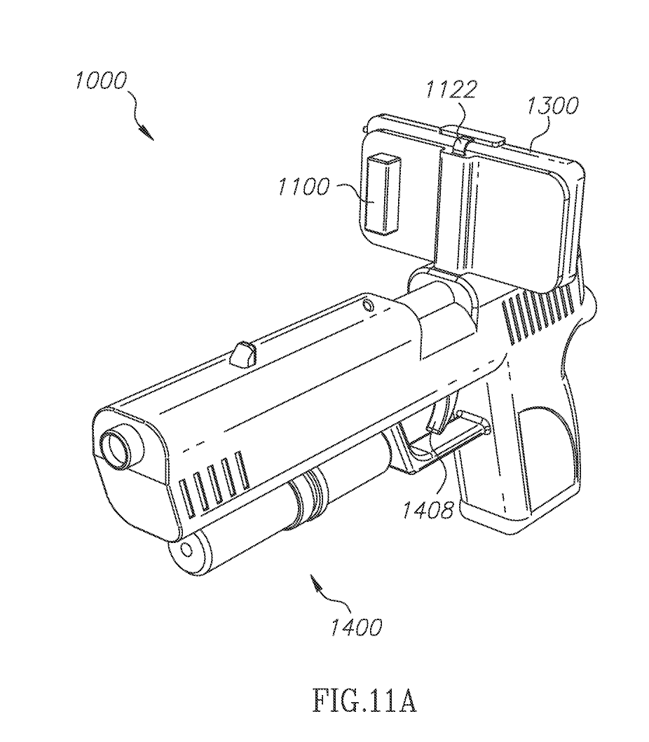

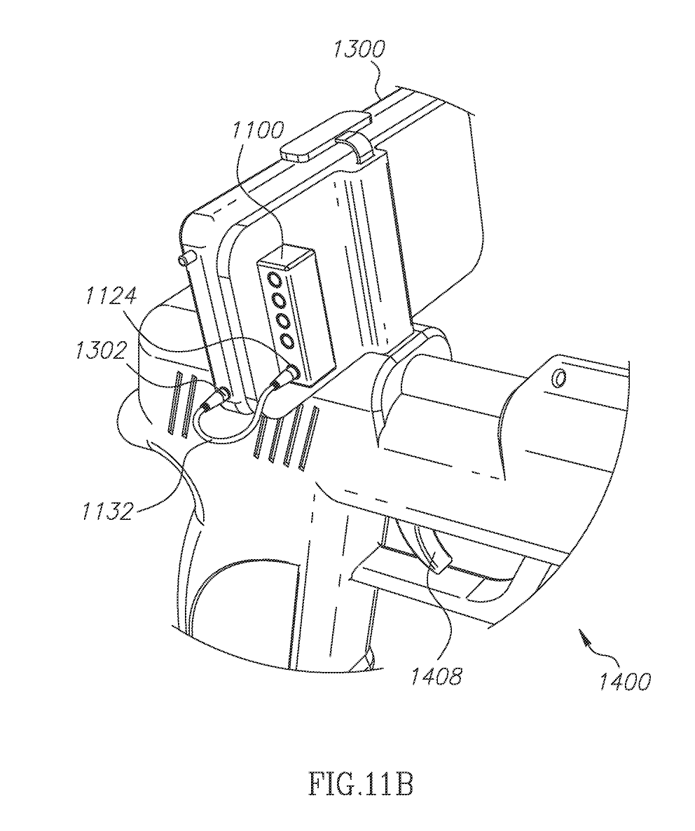

FIG. 11A illustrates gaming unit 1000 showing a perspective front view of gun-shaped gaming instrument 1400. In this figure, the back of pressure clasp 1122 is shown holding a standard end-user device as a cellular phone 1300 and coupled with an embodiment of a universal gaming controller 1100. Other means for coupling standard end-user devices to special purpose gaming instruments may be used, such as a case into which the end-user device may be inserted in a groove in the special purpose gaming instrument through which the device may be threaded.

Reference is made to FIG. 11B illustrating a close up view of gun-shaped gaming instrument 1400. Gaming controller 1100 is shown connected via one of plugs 1124 to a standard port 1302 of electronic device 1300 via cable 1132 connecting the data exchange unit (1130 in FIG. 9A) within controller 1100 to end-user device 1300. Standard pod 1302 may be, for example and without limitation, the microphone input jack or headset connector of the cellular phone that is used as an end-user device. Controller 1100 may be capable of controlling the software gaming application installed on end-user device 1300 for example by transmitting data using pre-defined audio signals to the end-user device via the microphone input port 1302.

Alternatively, port 1302 may be a USB port or other standard port as used with common end-user devices such as cellular phones, media players and PDAs. Other data exchange means may be used, for example wireless transmission which does not require a cable such as Bluetooth etc.

Optionally, the data exchange means can also be used by the gaming controller for receiving power from the end-user device. Alternatively or additionally, the controller may include an independent power source, for example a battery or a rechargeable battery.

In some exemplary embodiments, controller is a rudimentary controller serving to physically connect end-user device to the gaming instrument and to transfer rudimentary commands such as trigger puling from the gaming instrument to the end-user device. In these embodiments, controller 1100 may be devoid of a battery. For example, trigger 1408 may be used for creation of electrical short circuit across microphone input terminals of microphone input port 1302. The electrical spike created, or the difference in electrical noise characteristics of the signal on port; 1302 may be detected by end-user device 1300.

A gaming application typically includes a software component configured to be installed on end-user devices allowing integration with third-party operating systems such as the Google's Android, Apple's iOS (iPhone and iPAD), and other smart phones, media players and PDAs, The software component uses processing and communication capabilities of the end-user device to process information received from the universal controller, display some or ail of the processed information on a screen of the device, and send part or all of the information to other end-user devices and central servers according to need.

FIG. 9C is a block diagram illustrating a plurality of gaming units interacting with each other via a common server. A gaming system 900 comprises a plurality of interacting gaming units 1000a, 1000b and 1000c. Communications may be via long range link such as cellular 999 connecting gaming unit 1000a with server 2000 (for clarity, cellular infrastructure is not seen), or short range communicating 997 such as Bluetooth, Wi-Fi IR etc.

Server 2000 may be located in a PC in the room where the game is played or on one of the devices participating in the game (may be referred to herein as “local”, or remote). A remote server 2000 may be interfaced indirectly, for example via the internet. For example one gaming unit 1000b, or a plurality of gaming unit 1000b and 1000c may communicate with a wireless router 998 which is in communication with the server 2000.

Alternatively, a plurality of gaming units 1000 may communicate directly with each other.

For example, in the shooting simulation game, a plurality of gaming units 1000, each comprising a gun-shaped gaming instrument 1400 may be used. A controller 1100 coupled to each of the gun-shaped gaming instruments aggregates real time data about actions performed with the device, such as pulling the trigger 1408 of the toy gun 1400. The data is transferred via data exchange unit (1130 in FIG. 9A) such as a cable (1132 in FIG. 11B) to the software components installed on the end-user device 1300. In other embodiments, other transfer methods may be used, for example and without limitation RF transmission.

Either the gaming instrument 1400, the controller 1100 itself, or the end-user device 1300 to which it is coupled, may contain sensors capable of measuring data such as the location of the instrument, where the instrument is pointing, the movement of the instrument, or the like. The data is then optionally sent via cable 1132 to be used by the software application installed on end-user device 1300. The application may process the information and send it to a central server 1200 and to other gaming units 1000 registered for the game.

Other than data received from the sensors, controller 1100 may further report actions performed using gun-shaped gaming instrument 1400 to the software application on end-user device 1300, actions such as but not limited to pushing buttons or pulling trigger 1408. For example, an electrical circuit may be activated when a button on an end-user device is pushed, and/or when a trigger is pulled, or other such actions. Data representing the action reported by the activated electric circuit is transmitted via connection ports connecting special-purpose gaming instrument embodiments to controller embodiments, connection ports such as 1480 of toy gun 1400 and port 1180 on controller 1100 as illustrated in FIGS. 108 and 10C.

Controller 1100 may also be used to receive commands from the software application installed on end-user device 1300 and send them to embodiments of the gaming instrument such as toy gun 1400. An example for such a command may be to provide visual, audio, vocal or tactile input to a user holding toy gun 1400, visual input such as lighting a LED light, tactile input such as vibration, heat or any other tactile options available for end-user device 1300. These examples are for illustration purposes only, and should not be looked at as limiting.

Data regarding pulling trigger 1408 may be translated by controller 1100 to digital input if controller 1100 uses a USB digital port for connecting to end-user device 1300, Alternatively if used with a cellular phone's microphone port, the port 1302 may be configured to receive only sound signals; in this case, controller 1100 may translate data regarding pulling trigger 1408 to a sound which is later interpreted by the software application on the end-user device 1300. Data received from the sensors in sensor unit 1210 (FIG. 9B) may also be translated to pre-defined digital or sound formats which can then be transmitted to the standard voice entry of end-user device 1300, Different sound patterns may be used for data transfer to differentiate between the different sensors. Different data modulation techniques may be used to transfer the data (such as FM, AM, or the like).

The controller is typically capable of connecting to a plurality of end user device types. Data transfer to the devices may be via sound entry as described above. Alternatively, light effects may be used to transfer data to end-user devices which contain a camera. Different light patterns optionally produced by different colored LED lights may be produced, and the camera installed within the end-user device can be used to recognize these patterns and pass them to the software gaming application. Other options for data transfer are various radio frequency methods of transmission such as but not limited to Bluetooth or magnetic induction.

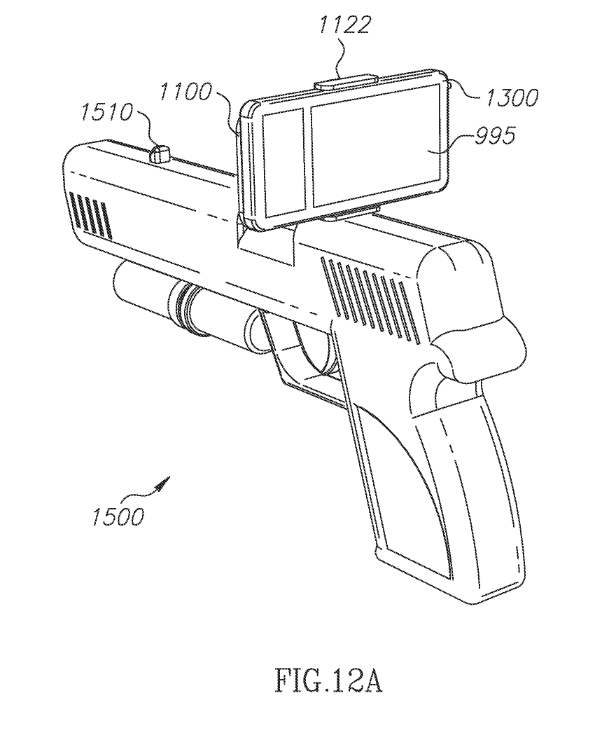

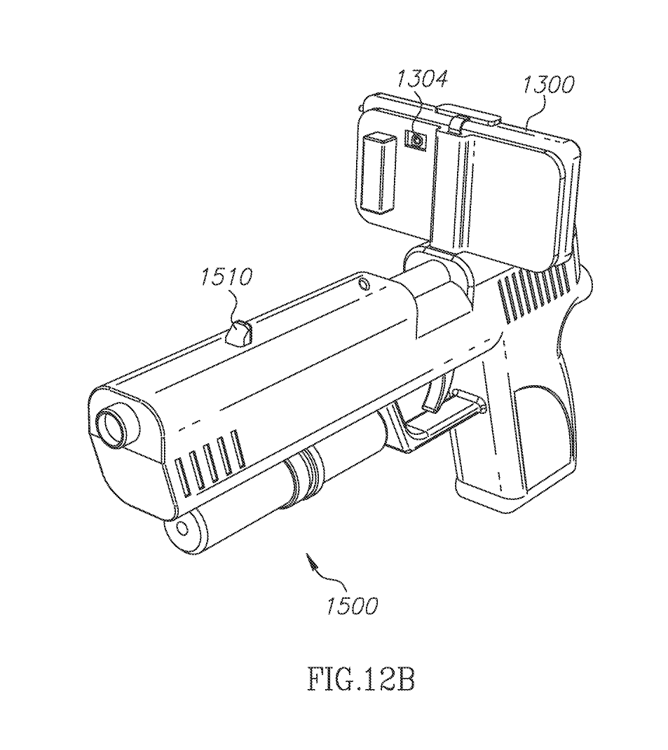

FIG. 12A illustrates a rear view of an embodiment of a special purpose gaming device 1500 in the shape of a toy gun further comprising a light emitting mechanism 1510 capable of receiving commands from controller 1100.

FIG. 12B illustrates a front view of device 1500, further showing a camera lens 1304 of cellular phone that is used as an end-user device 1300, pointing at light emitting mechanism 1510. Light patterns produced by light emitting mechanism 1510 may represent the different actions reported by the controller, and transmitted to camera lens 1304 visually.

Gaming instruments are not limited to toy guns, and may include other shapes such as steering wheels for driving games, swords, wands and batons for magic-related games, or any other shape which suits requirements of the gaming application.

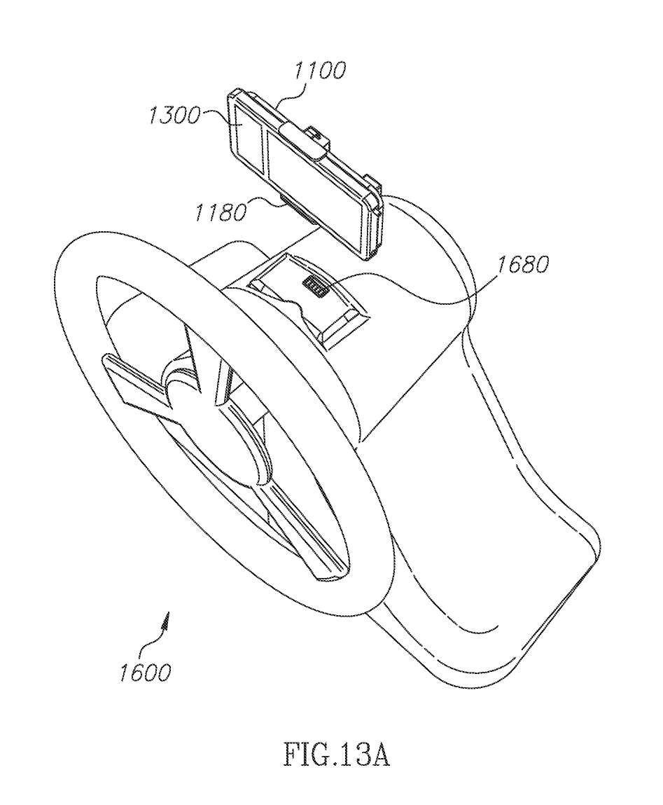

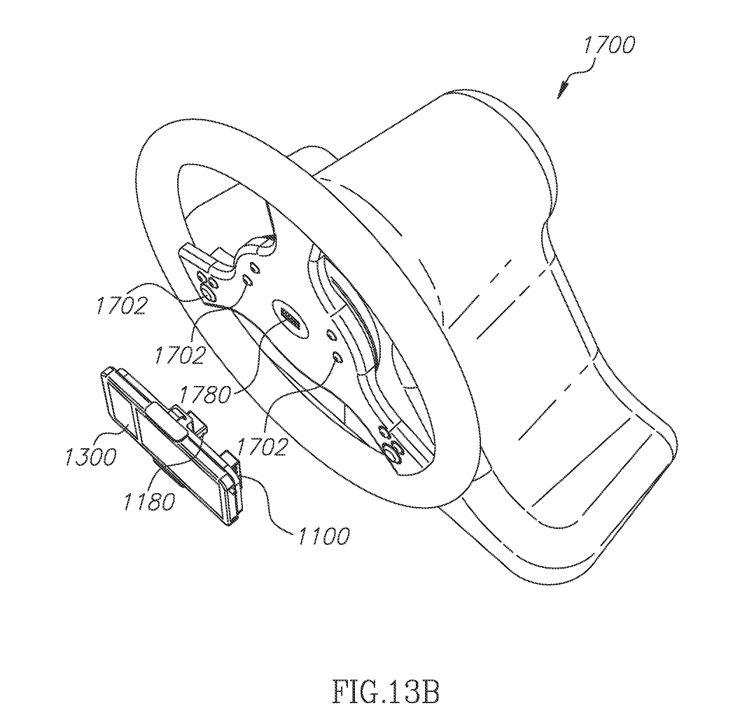

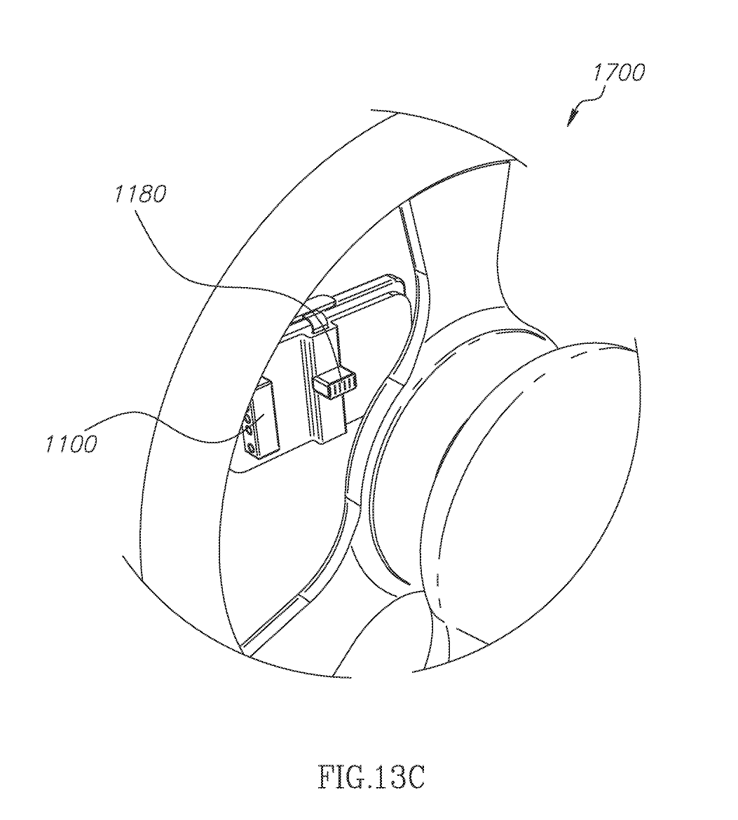

FIG. 13A illustrates a gaming instrument in the shape of a steering wheel 1600 with an embedded male connection port 1680, that matches a female part connection port 1180 embedded into a controller 1100. In this embodiment, the controller 1100 is configured to be coupled to the non-rotatable top of the wheel 1600.

FIGS. 13B and 13C illustrate a second steering wheel embodiment 1700 in which controller 1100 is configured to be coupled to the center of steering wheel 1700 using male part of connection port 1780 on the steering wheel and female part 1180 of the connection port on controller 1100. Steering wheel 1700 comprises also buttons 1702. Pushing the buttons on steering wheel 1700 is recognized by controller 1100 and transferred to the software application installed on the end-user electronic device. Button pressing may represent, for example and without limitation, virtual shift-stick control, virtual 4-wheel drive capabilities, or other common driving features which may be simulated in a game.

Capabilities of gaming instruments vary according to shapes and uses, and may include virtual shooting, pointing, twisting or the like. It should he noted that different gaming instruments may be used in standalone single-player mode, or alternatively in multi-player mode with similar or different applications capable of communicating with a central server or with each other, according to gaming rules. Communication may be triggered by gaming instruments, end-user electronic devices, or combinations thereof.

In exemplary embodiments, the application is preferably configured to be installed on smart phones, media players and PDA devices capable of wireless communication with a central station and/or with each other typically over the internet. User interaction is often achieved through utilization of technologies such as web surfing, instant messaging, video and audio streaming.

Optionally, the application is capable of automatic identification of different types of special-purpose gaming instruments. For example, the application is capable of differentiating between a toy gun shaped instrument and a wheel shaped instrument. This can be performed, for example and without limitation, by a simple handshake which fakes place when the end user device is coupled to the controller or when the end-user electronic device and controller communicate. Upon coupling, the controller coupled to a special-purpose gaming instrument may send a bit sequence to the end-user electronic device that uniquely identifies the special-purpose gaming instrument The bit sequence may be transmitted to the end-user electronic device by means of voice to the microphone entrance of the device. Different bit sequences may be used for different special-purpose gaming instruments.

Dedicated ASIC, may be provided to manufacturers of special-purpose gaming instruments for defining their instruments and coupling to applications on electronic devices such as cellular phones, PDAs, music players or the like. In addition, a software development kit (SDK) may be provided to software developers for allowing the development of various controller-applications for the universal gaming controllers. Controller-applications typically interact with electronic-device-applications: a controller-application may define the actions that can be performed on the trigger within the physical host as well as the trigger-data that will he sent to the electronic end-user device in response to these actions. Examples of physical actions are pulling a toy-gun trigger, turning a steering wheel or pushing a button on a physical host. Trigger-data may he Boolean (for example and without limitation: the trigger was pulled: YES/NO), or optionally comprise more parameters such as but not limited to a timestamp of the action, the speed at which the action was performed, the direction at which the object was pointing to, or other parameters which suit requirements.

In some embodiments, the controller-application will also define the controller's impact on the physical host in response to feedback-commands received from the controller. For example and without limitation, a controller-application may define a ‘retraction’ tactile effect in response to pulling a trigger on a toy gun, which can optionally be implemented by an electric current or a shake supplied to the toy-gun handle, such that when the user is holding the toy-gun handle and pulling the trigger he will feel the effect upon his hand.

An electronic-device application will typically assist in defining the gaming scenario and the gaming responses to trigger-data received from the controller regarding physical actions performed on the physical host. For example and without limitation, a response to trigger-data regarding polling the trigger on a toy-gun in direction X may be:
calculating targets positioned relative to the direction received in the trigger-data
generating a ‘hit’ effect on a the screen of the electronic device
sending the ‘hit’ command to a central server or to another end-user electronic device.

Sample applications may include variations, combinations and sub combinations of the scenarios presented herein:
A single-player shooting simulation: a smart phone is connected to a gaming controller assembled upon a toy-gun having a trigger and optionally several push buttons. The player is engaged in a shooting simulation/game that is an application presented upon the smart-phone's screen. Pulling the toy-gun trigger is interpreted in the application as a shooting event, and pushing specific buttons may be interpreted as loading the gun or throwing grenades in the application The controller may further be used to influence occurrences within the gaming application, for example forward and backward movements of a player within the game.
A multi-player sword game; a smart phone is connected to a gaming controller assembled upon a plastic toy sword comprising a handle with several buttons, in other embodiments, the handle may also be provided with touch and pressure sensors. Players engage in a combat scenario in which the smartphone's sensors provide information about its location and orientation. Pushing the buttons upon the handle may change the sword's virtual characteristics in the gaming application, such as but not limited to a fire-sword, a water sword, the length of the sword, etc.
A car game: a smart phone is connected to a gaming controller assembled upon a toy wheel such as illustrated in FIGS. 13A-13C. The application installed on the smart phone may simulate a road with cars, in which one car is controlled by the player and optionally other cars are controlled by other players. The application simulates a view of the road, according to its interpretation of wheel steering clockwise and counterclockwise.
Music games; the control box is coupled to a toy musical instrument in the shape of a flute, a guitar or the like. Pushing buttons on the toy musical instrument may result in vocal effects emerging from the cellular phone.
Stuffed animals games: pushing, pulling and squeezing a stuffed animal coupled with a controller may result in an interactive doll.

It is to be noted to the skilled practitioner that other applications and combinations of toy devices may also be used.

The same physical buttons on a special purpose gaming device may have different functionality in different applications. For example, pushing a button on a special purpose gaming device may be translated by one application as a gun fire, and in another application as throwing a fishhook or dropping an object.

The optionally modular construction of the gaming unit is advantageous as it can be easily adapted to variety of games, gaming instruments and hand held electronic end-user devices with minimal design and manufacturing efforts. Once a controller is designed to physically hold a type or several types of electronic end-user devices, it may be used with a variety of gaming instruments due to standardization of connector. Thus, new games may be added by creation of new gaming instruments. The user upgrades the game by purchasing new gaming instruments.

Similarly, different electronic end-user devices may be used by attaching them to the controller. In many cases, this can be done using the same controller due to the standardization of the ports and the similar physical dimensions of the electronic end-user devices that may be clasped by the connecting clasp. More flexibility may be offered by providing a selection of cables, or an adaptation of controller or its physical connector.

It should be noted that the gaming platform described herein may be used in situations other than gaming. For example, the shooting game simulation may serve for training of military and security personnel. The steering wheel simulation may serve for driver training.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in ibis specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The scope of the present invention is defined by the appended claims and includes both combinations and sub combinations of the various features described hereinabove as well as variations and modifications thereof, which would occur to persons skilled in the art upon reading the foregoing description.

1. A universal gaming controller for enabling connectivity between at least one physical host having at least one physical trigger configured to be operated by at least one user, thereby generating trigger-data, and at least one electronic device having at least one port capable of receiving data and capable of being controlled by at least one user, the controller comprising:
a housing configured to he physically coupled with at least one of the physical hosts and at least one of the electronic devices; and
a connector configured to allow trigger-data transfer between at least one physical trigger of the coupled physical hosts and at least one port of the coupled electronic devices,
whereby said trigger-data is transferred to said at least one electronic device via said at least one port.

2. The universal gaming controller of claim 1, further comprising an exchange unit configured, to allow transfer of feedback-commands between the physically coupled electronic devices and said connector.

3. The universal gaming controller of claim 2, wherein said exchange unit further comprises a command and control unit configured to allow generating impacts upon the physically coupled physical hosts according to feedback-commands received from the physically coupled electronic devices.

4. The universal gaming controller of claim 2, wherein said exchange unit is further configured to enable communication between the electronic devices and at least one gaming-server, and said gaming server is capable of:
receiving user-game-data generated by the controller;
sending game-field-data to the electronic devices; and
sending feedback-commands to the controller via the electronic devices.

5. The universal gaming controller of claim 4, wherein said gaming-servers are configured to process game-field-data received from multiple sources into an augmented-reality platform.

6. The universal gaming controller of claim 5, wherein said, game-field data comprises static-game-field-data and dynamic-game-field-data.

7. The universal, gaining controller of claim 1, configured to he retrofitted upon the physical, hosts.

8. The universal gaming controller of claim 1, wherein said physical hosts can be hand-held.

9. The universal gaining controller of claim 3, wherein said impact, is selected from the group consisting of visual impact, audial impact, tactile impact and olfactory impact.

10. The universal gaming controller of claim 1, wherein said at least one port that is capable of receiving data is a port of available electronic devices.

11. The universal gaming controller of claim 10, wherein said at least one port is selected from the group consisting of microphone port, camera, button, touch screen, blue-tooth, and WiFi.

12. The universal gaming controller of claim 1, wherein said electronic devices are each independently selected from the group consisting of smart-phones, PDAs, portable gaming devices, portable media players and portable gaming consoles.

13. The universal gaming controller of claim 1, wherein said, physical host is selected from the group consisting of toy guns, grenade launchers, missile launchers, steering wheels, wands, plush toys, board games and swords.

14. The universal gaming controller of claim 1, wherein the electronic devices each further comprise at least one data collection unit, each said data collection unit configured to allow collecting data received from, at least one physically coupled physical trigger and from at least one sensor.

15. The universal gaming controller of claim 14, wherein said at least one sensor is each independently selected from the group consisting of GPS locators, gyroscopes, acceterometers, compasses, and tactile sensors.

16. The universal gaming controller of claim 1, wherein said controller further comprises an end-user output unit.

17. The universal gaming controller of claim 1, wherein the electronic device further comprises an end-user output unit.

18. The universal gaming controller of claim 16, wherein said end-user output unit is selected from the group consisting of screens, loudspeakers, LEDs, illuminating components and vibratory components.

19. The universal gaming controller of claim 14, further comprising an end-user storage unit configured to store data aggregated by said data collection unit.

20. A gaming host comprising:
at least one physical, trigger configured, to be operated by at least one user and thereby generating trigger-data;
a housing configured to be coupled with at least one electronic device having at least one port capable of receiving said trigger-data;
at least one gaming controller configured to allow data transfer to said at least one electronic device; and
a connector configured to allow transfer of said trigger-data to said at least one port.

21.-25. (canceled)

26. The universal gaming controller of claim 17, wherein said end-user output unit is selected from the group consisting of screens, loud speakers, LEDs, illuminating components and vibratory components.
